(19) United States
(12) Patent Application Publication
(10) Pub. No.: US 2011/0141522 A1
(43) Pub. Date: Jun. 16, 2011

(54) Identification Card

(76) Inventor: Andras Vago, Budapest (HU)

(21) Appl. No.: 13/058,583

(22) PCT Filed: Aug. 13, 2009
(86) PCT No.: PCT/EP2009/060489

§ 371 Date: Feb. 11, 2011

(30) Foreign Application Priority Data
Aug. 13, 2008 (DE) 10 2008 038 990.0

(51) Int. Cl. G06K 15/00

(52) U.S. Cl. 358/1.18

(57) ABSTRACT

In order to produce a highly effective security feature on a substrate material in a simple manner, a printed image is applied to one side and a laser image is applied to the other side in an at least partially congruent fashion, in particular on a transparent part of the substrate and from different sides.

### I. FIELD OF THE INVENTION

The invention relates identification cards and their tamper resistance.

### II. BACKGROUND OF THE INVENTION

Identification cards which are used by themselves as ID cards, credit cards or similar in large numbers or which are also tied into conventional passports typically include one or plural plastic layers, wherein one of the plastic layers is used as a substrate and thus as a carrier material for other layers to be applied thereto, e.g. imprinted images and similar which are typically covered with an additional transparent protective layer.

In order to improve tamper resistance different options are known with respect to the images or logos to be applied to the card. One option is to apply a laser image which is lasered into the surface of the substrate which is disposed below the printed image visible to the viewer, wherein the printed image can be applied with various printing technologies and wherein the laser image is normally not visible to the viewer.

Only when attempting to remove the superimposed print image entirely or partially for the purpose of manipulating the card for changing the printed image or applying a new printed image, the laser image disposed there under becomes visible which is only removable with great difficulty without destroying the card.

However, it is a disadvantage of this safety measure that when the printed image is successfully and completely removed and a new falsified printed image is applied which is not transparent, a viewer cannot subsequently detect the lack of coincidence of the applied falsified printed image with the laser image disposed there under due to the lack of transparency of the applied new printed image.

Another disadvantage with respect to the manufacturing process for this safety feature is that applying the printed image and the laser image, which has to be performed from the same side of the substrate, is virtually impossible in the same process station.

However, when these two images are applied in two spatially separated, though closely adjacent work stations, the card and the portion for applying the image have to be readjusted in particular in the second work station in order to match the preexisting first image which necessitates a complex so called registering of the card and makes it more difficult for the two images to coincide exactly.

### III. DESCRIPTION OF THE INVENTION

### a) Technical Object

Thus, it is the object of the invention to provide an identification card and a method to produce the card which in spite of simple and economical manufacture provides a high level of safety against manipulations and a simple detection for manipulations that may have been performed.

### b) Solution

This object is achieved through the features of claims 1 and 21. Advantageous embodiments can be derived from the dependent claims.

Besides simplified production and a high level of tamper resistance the object is for a viewer to be able to detect the coincidence of at least two images that area provided on the card, thus in this case of a printed image and a laser generated image, thus preferably without having to turn the card over.

This can be facilitated in that the printed image and the laser generated image are disposed on the card on top of one another or also adjacent to one another, however on different sides of the substrate for simplified production.

For this purpose the substrate should namely be transparent in the portion of the image, however, there is the advantage that the printed image and the laser generated image can be applied during production from different sides of the substrate and thus can be applied simultaneously or at least at the same work station without having to re-register the card for a second process step.

In case the substrate is not transparent during this process, the viewer has to turn the card over in order to subsequently view both images from both sides of the substrate and check the matching of the images.

If the printed image and the laser generated image are disposed next to one another, thus supplement one another to form a total image, they can also be applied on the same side of the substrate and in the same process step without having to re-register the card. Then it is not mandatory that the substrate is transparent in this portion.

In order to produce the laser generated image the layer that is being used has to be made from a laser sensitive material. Preferably a laser sensitive material is directly used as a substrate for this purpose, or the substrate is coated with a respective layer made from this material on the respective side.

In order to provide transparency in the portion of the images a transparent substrate can be selected to begin with, or the so called window technique can be used.

Thus, in the portion in which a transparent material is required, a pass through is produced in the substrate, wherein the pass through extends from the front side to the back side and is made from a non transparent material and is thus filled with a window material which is transparent. Thus, the window material is preferably filled into the pass through in a liquid form and cured, preferably through irradiation with ultra violet light which typically accelerates the curing when the materials are adjusted to it.

Materials can be introduced into the card as window materials in the same manner, wherein the materials have different physical or chemical properties relative to the remaining substrate. Thus, inserts can also be inserted into the window material, in the simplest case a flat three dimensional element or an image that is separately produced through a printing technique or through a different method. This image will preferably be another control image which should coincide with the printed image and/or the laser generated image.

However, also microscopic components, e.g. nano particles can be inserted into the window material, e.g. microscopic components which cause a particular optical effect.

Thus, nano scales or nano threads can be inserted into the window material which reflect incident light in a specific manner which is achieved by hardly any other material and thus provides a high recognition effect for the user.

Thus micro capsules can also be encased into the window material, wherein the micro capsules are filled with colorants and their shells can be caused to burst through irradiation with light with a particular wave length, thus causing coloration in the window.

By introducing different micro capsules whose shells can be caused to burst as a function of the included color respectively at defined wave lengths, even particular colorations can be provided in a defined manner and thereby even a multi colored image can be subsequently generated in the window through irradiation with particular wave lengths in particular surface portions.

The window can also be filled with a suitable material which includes an electrically conductible plastic material, so that an image can be generated like on a display after curing and controlled application of a suitable electric voltage. An image of this type can be permanently fixated by sealing the electrical connections, e.g. with a final sealing layer applied on one or both outer surfaces of the card.

The elements or properties besides being applied in the window portion can also be applied on the remaining surface of the card by providing a respective coating of the substrate in this location.

The final coating with a transparent material configured as a protective layer on the outsides of the card shall include in particular nano particles which have a biocide effect on the one hand side e.g. in that they include silver atoms or silver molecules, and furthermore have high scratch resistance, thus providing the lowest adhesion for foreign objects possible in order to avoid contamination of the card.

Thus, in particular the biocide effect is paramount for the time being, since it is known by now that germs can be transmitted from one card surface to another by high volume contacting of cards, e.g. through commercially available card readers and thus the germs can be transferred from one card holder to the next.

Thus, the two images are produced on the substrate for efficiency reasons as follows.

Initially the substrate that is placed in processing position and in which a window is provided which is filled with transparent material is optically scanned, e.g. by producing a digital image in order to determine the exact position of the window.

Thus, e.g. the boundaries, thus the edges of the typically rectangular window are determined in the substrate. For this purpose known methods are available e.g. by determining the position of the edges on the CCD-sensor of the camera, so that the actual position of the window is computable in the operating position due to the known relative position and the distance of the camera from the operating position of the substrate.

An original in the form of image data has to be provided for the image which shall be arranged on the substrate on the one hand side as a print image and on the other hand side as a laser image.

The image data is initially adapted to the size of the window and its position in that a rotation of the image thus of the image data is optionally provided, so that the image is subsequently represented in the card in the desired orientation. Additionally, the size of the image often has to be adapted to the size of the window by changing the image data and a positioning of the adapted image data has to be performed with respect to the position of the window.

Subsequently, the adapted image data is processed for applying the image to the substrate.

On the one hand side known noise suppression methods are performed upon the image data, the contrast is set and possibly, in case it is a color image, the color intensity of the particular colors is adjusted.

Subsequently the first image, thus the laser image or the print image can be applied on the substrate with a respective device in the portion of the window.

Depending on whether the other image to be applied on the opposite side shall subsequently be applied from the same operating side or not, the substrate is now turned over in the operating position or not before the second image is applied.

If the substrate is turned over, the first image that is already applied has to be found with respect to its position which in turn is performed through optical scanning.

Either the contour of the applied first image itself is optically scanned for this purpose, or in turn the window is scanned with respect to its boundaries, since the position of the applied first image relative to the frame of the window in consideration of the mirrored arrangement on the back side is already known.

Subsequently the respective adaptations and preparations have to be performed in turn with the original image data as described for the first image and possibly an additional adaptation of the image data is required for the first image with respect to the already produced second image.

Since the second image is applied to the backside of the substrate and the images shall overlap at least partially in a congruent manner, mirroring the image data is also required as a preparation for the second image.

Subsequently the second image, thus the laser image or the print image can now be applied.

When preparing image data for the laser image, typically transposing the image data from a colored original image into a black and white original image has to be additionally performed.

When preparing image data for the laser image eventually, when the image to be printed is a color image, the gray scale should be selected so that the color effect of the printed image is not distorted too much, preferably not distorted at all.

Also the process steps for producing the window or the predisposed process steps can be optimized.

Already before producing the window, this means when the substrate is still made from continuous substrate material without window, a basic design is applied to the substrate on one side or on both sides, e.g. through imprinting or applying a respectively configured foil.

Since the window or the pass through for the subsequent window in the substrate shall subsequently be performed through punching, reference marks for punching are already applied to the substrate for this basic design, wherein the punch reference marks are subsequently being used as reference marks during punching.

When applying the basic design additionally one or plural desired safety features like imprinting an iris, a micro print image, Guilloches or an UV detectable print image are applied.

Subsequently the pass through for the subsequent window is punched out of the substrate that is provided with the basic design using a punching tool and preferably the subsequent window is punched out of the transparent window material using the same tool.

The punched out piece made from window material is subsequently inserted into the pass through in the substrate into which it has to fit based on being produced with the same tool and is attached there e.g. through welding or through laminating by over laminating a foil on one or both sides which extend over the window and the substrate.

### c) Embodiments

Embodiments of the invention are subsequently described with reference to drawing figures, wherein:

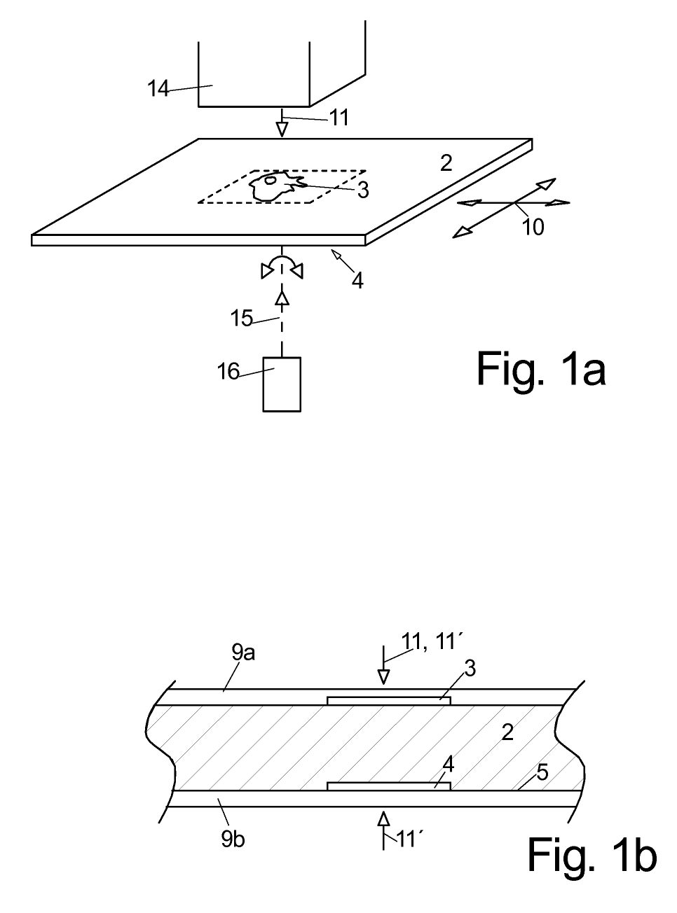

FIG. 1a illustrates the production of a card according to the invention;

FIG. 1b illustrates a version of the finished card;

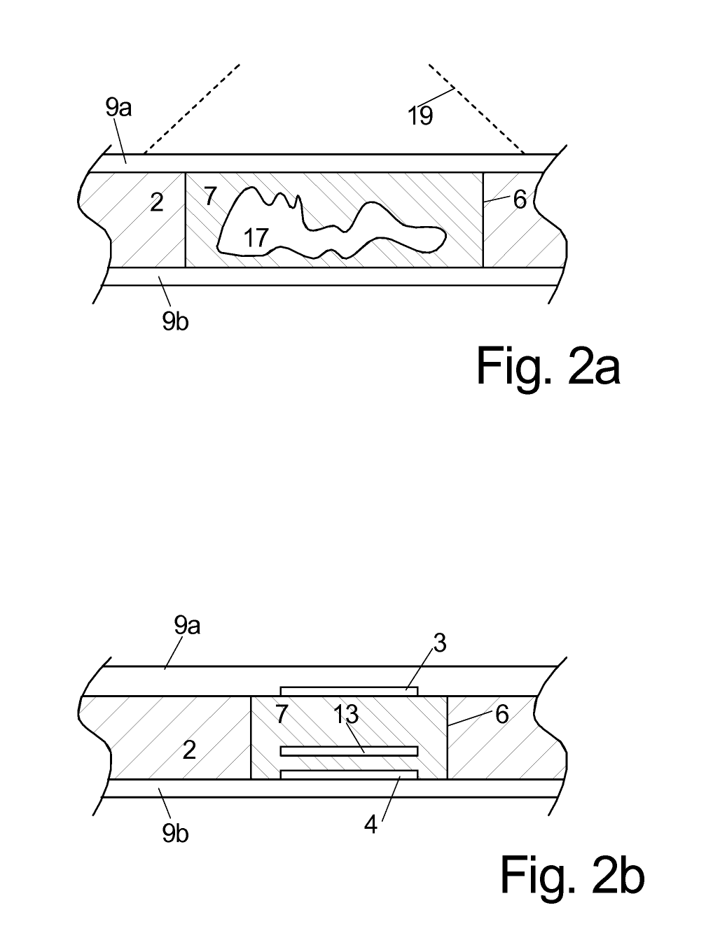

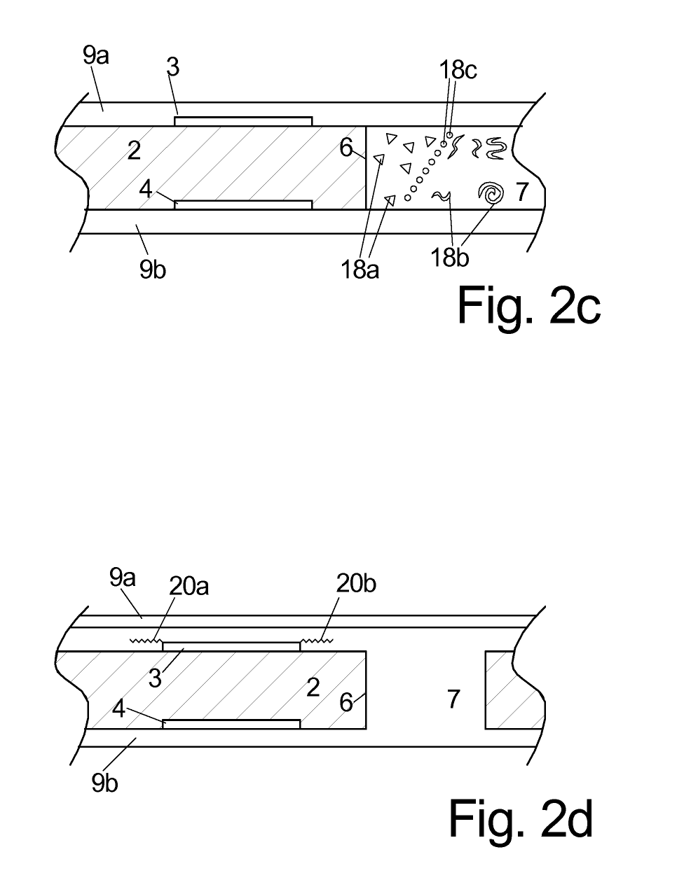

FIG. 2a, b illustrates a version with macroscopic inserts;

FIG. 2 c illustrates a version with microscopic inserts;

FIG. 2d illustrates a version without visible inserts.

FIG. 1a illustrates how on the one hand side the print image 3 is applied e.g. through a print stamp 14 or another print method on a substrate 2 in one process step and at the same operating position of the substrate 2 from opposite directions to the main plane 10 of the substrate 2 and the laser image 4 is applied through a laser beam 15 originating at a laser source 16 from the other side from the other side from the other side.

Since the print image 3 and the laser generated image 4 are applied congruently viewed in transversal direction, thus with identical size, position and rotation on different sides of the substrate 2 as evident from the cut view of FIG. 1b, a viewer can check coincidence of the two images 3, 4 from each of the two viewing directions 11′, as long as the substrate 2 is transparent at least in the portion of the images 3, 4.

The protective layers 9a, b protecting the outsides of the substrate 2, wherein the protective layers cover the print image 3 and the laser generated image 4 are typically always provided transparent anyhow.

If the substrate 2 is not transparent the viewer has to turn the card 1 once for controlling both images.

A substrate 2 that is transparent in certain card portions can also be provided in that a pass through 6 is generated in the substrate 2 as illustrated in FIG. 2 and this pass through 6 is closed with a window material 7 which is typically applied in a liquid form and cured, e.g. through curing with UV radiation 19.

Also in the card 1 individual inserts 8 can be introduced into the window material 7 when it is introduced into the window in a liquid form.

An insert 8 of this type can be e.g. a single three dimensional object 17 which is flat enough, so that it fits within the thickness of the substrate 2.

An insert 8 of this type can also be a control image 13 previously produced through a print technique or similar, wherein the control image is configured as a print image or hologram. Thus, preferably the control image 13 is an image which coincides with the subsequent print image 3 and the laser generated image 4 with respect to motive size, rotation and position which certainly requires a prior alignment of the control image 13 in the operating station for applying the print image 3 and the laser generated image 4.

Also very small, quasi microscopic but still visible components can be used for inserts 8 as illustrated in FIG. 2c.

E. g. so called nano scales 18a, thus very small nano particles which however cause a particular light reflection which is not generated by any other material in a similar manner. The same applies for so called Nanoflaves 18b which are substantially string shaped and also cause a specific light reflection or light fraction which is typical for these particles.

Another option is embedding the known micro capsules 18 which are filled with colorants and can be used for generating also multi colored images through subsequent destruction of the embedded capsule shells in order to generate a spatially defined coloration of the window material 7.

The advantage of inserts 8 of this type is that they can only be removed or manipulated when destroying the window material 7 of the card 1, which certainly becomes visible at the card 1.

Obtaining the same effect in particular the same optical effect, however, though other particles or elements is hardly possible or only possible with high complexity.

In the latter case of using quasi microscopic components as inserts 8 it is not useful anymore to apply the print image 3 and the laser image 4 in the same portion of the substrate 2 so that they can be applied offset relative to the windows 7, however, still coincidental with one another. Thus, preferably the substrate 2 is also transparent in the portion of the images 3 and 4.

FIG. 2d illustrates a variant in which, the illustration of inserts was thus omitted for reasons of simplification, the material from which the window 7 is cast is simultaneously applied to the top side of the substrate 2, preferably in the same process step.

It is illustrated on the bottom side of the substrate 2 that the window material 7 is simultaneously used as lower protective layer 9b when the window material 7 has the suitable properties.

It is illustrated on the top side of the substrate 2 that also the top side of the substrate 2 is covered with the window material 7, in particular the entire top side thus preferably also the print image 3. The window material 7, however, is only used herein as an intermediary layer 12 which is subsequently coated with an upper protective layer 9a which then has the properties stipulated for the protective layers 9a, b, typically transparent, additionally preferably biocide scratch resistant and with low adhesion which is preferably achieved through nano coating.

Thus, it is illustrated with respect to the print image 3 that the print image 3 can also be produced in the form of a display and the applied print image 3 also includes a layer made from electrically conductive plastic material by obtaining a visible image only through applying an electrical current to the illustrated electrical contacts 20a, b, wherein the image is then permanently maintained through disconnecting the electrical voltage.

Thus, changing the obtained image is not possible anymore after applying and sealing the electrical contacts, in this case through the intermediary layer 12.

### REFERENCE NUMERALS AND DESIGNATIONS

1 card
2 substrate
3 print image
4 laser generated image
5 laser sensitive layer
6 pass through
7 window material
8 insert component
9a, b protective layer
10 main plane
11 transversal direction
11′ viewing direction
12 intermediary layer
13 control image
14 print stamp
15 laser beam
16 laser source
17 three dimensional object
18a, b, c micro particles
19 UV rays
20a, b electrical contacts

What is claimed is:

1. An identification card, comprising:
a substrate configured as a carrier material;
a print image; and
a laser generated image, wherein the print image and the laser generated image are arranged on the card so that they coincide with respect to size, position and rotation viewed in a transversal direction relative to a main plane.

2. The identification card according to claim 1, wherein the printed image and the laser generated image are arranged on different sides of the card (1) with respect to the substrate.

3. The identification card according to claim 1,
wherein at least one of the two images is at least partially transparent; and
wherein the substrate is transparent at least in the portion of the images.

4. The identification card according to claim 1, wherein the laser generated image is arranged on the backside of the substrate or on a laser sensitive layer separately arranged on the backside of the substrate.

5. The identification card according to claim 1, wherein the substrate in the portion of the images, in particular in a portion that is larger than the portion of the images, includes a pass through which extends from the front side of the substrate to the backside of the substrate, wherein the pass through is filled with a window material which differs from the material of the substrate.

6. The identification card according to claim 5, wherein the window material is transparent and the substrate is not transparent.

7. The identification card according to claim 5, wherein the window material is laser sensitive and the substrate is preferably not laser sensitive.

8. The identification card according to claim 5, wherein the substrate is also coated with the window material beyond the surface of the pass through at least on the front side of the substrate.

9. The identification card according to claim 1, wherein the print image is a print image produced according to a re-transfer method or a print image produced according to a tampon printing method.

10. The identification card according to claim 5, wherein inserts are embedded in the window material.

11. The identification card according to claim 10, wherein the insert is a flat three dimensional element.

12. The identification card according to claim 10, wherein the insert is a print image, in particular a hologram.

13. The identification card according to claim 10, wherein the insert is a laser sensitive foil and the substrate and also the window material is not laser sensitive.

14. The identification card according to claim 10, wherein the inserts are components with defined optical properties, in particular nano particles or nano threads with particular optical properties.

15. The identification card according to claim 5, wherein the window material includes a display, in particular configured as an electrically conductive plastic material on which an image can be generated through controlled application of an electrical voltage, wherein the image remains on the display permanently after curing and/or removing the electrical voltage.

16. The identification card according to claim 5, wherein the window material is configured integral in one piece together with an outer protective layer (through nano coating) which is arranged at least on one of the outsides of the card.

17. The identification card according to claim 16, wherein the outer protective layer includes nano particles or a nano coating whose particles have a biocide effect and include silver atoms in particular.

18. The identification card according to claim 17, wherein the included or applied nano particles have high scratch resistance and/or low surface adhesion force with respect to applied objects.

19. The identification card according to claim 5, wherein the image or image portion imparted in the window material are congruent with the print image and the laser image.

20. The identification card according to claim 1, wherein the print image and the laser generated image are portions of a total image, in particular of an ID-holder.

21. A method for producing an identification card with a substrate configured as a carrier material, a print image, a laser generated image, wherein the two images and are disposed on top of one another, comprising the steps of:
applying the print image and the laser generated image from different sides of the substrate.

22. The method according to claim 21, wherein the print image and the laser generated image are applied in the same working position of the substrate, in particular simultaneously.

23. The method according to claim 22, wherein a pass through in the substrate is filled with a transparent window material, in particular initially filled in a liquid form and cured, in particular through irradiation with an UV-laser before applying the print image and the laser generated image.

24. The method according to claim 21, wherein the print image and the laser generated image are applied in the portion of the window material.

25. The method according to claim 21 further comprising the steps of:
optically scanning the substrate which includes a window;
detecting boundaries and a size of the window;
adapting predetermined image data through:
possibly rotation of the image;
adaptation of the size of the image to the size of the window;
positioning the adapted image data to the position of the window;
preparing the image data for applying the image through:
performing noise suppression measures upon the image data;
adjusting the contrast;
optionally adjusting the color intensity of the particular colors;
applying the first image, optionally turning the substrate over;
optionally finding the position of the image already applied, either through determining the positions of the boundaries of the window and optionally comparing with the mirrored data of the previously determined position of the edges of the window before turning it over, or doing the same with the image itself;
adapting the predetermined image data according to the determined boundaries of the window through:
optionally rotating the image;
adapting the size of the image to the size of the window;
positioning the adapted image data according to the position of the window;
preparing the image data for applying the second image through:
mirroring the image data;
performing noise suppression measures upon the image data;
adjusting the contrast;
optionally adjusting the color intensity of particular colors;
adapting the image data to the first image already created; and
applying the second image.

26. The method according to claim 21, wherein a laser generated image is applied as a first image and as a second image in a first case and a print image is applied as a first and as a second image in a second case.

27. The method according to claim 21, wherein a transposition of colored original image data into black and white image data is performed before applying the laser generated image when preparing the image data.

28. The method according to claim 21, wherein at least one insert component, in particular a print image or hologram according to the subsequent print image and the laser generated image is embedded into the window material when filling the pass through with window material.

29. The method according to claim 23, wherein a position of an image or hologram embedded in the window material is used as a target in a working position for positioning the print image and the laser generated image.

30. The method according to claim 23, wherein during filling the pass through with the window material, in particular laser sensitive material, in particular also at least one of the outsides of the substrate, is also coated, in particular completely coated.

31. The method according to claim 23, wherein nano particles, in particular nano scales or nano threads or other small particles with defined physical or chemical properties are mixed with the window material before casting, in particular micro capsules filled with paint, whose shells can be destroyed by irradiation with light with a particular wave length.

32. The method according to claim 21, wherein micro capsules with different color fillings and accordingly with shells that respond to different wave lengths are simultaneously used in the window material.

33. The method according to claim 21, wherein the card is coated in a last process step on one or both outsides with a protective layer which has biocide, scratch resistant and low adhesion properties, in particular through included nano particles with these properties.

34. The method according to claim 23, wherein the window material or an intermediary layer between the substrate and the protective layer made from an electrically conductive plastic material are applied and cured and a control image is generated therein through controlled application of an electrical voltage, in particular in the portion of the pass through, and used as a target for a later application of the print image and the laser generated image.

35. The method according to claim 34, wherein the power supply to the electrically conductive intermediary layer is interrupted and its electrical contacts are sealed through the protective layer before applying the protective layer.

36. The method according to claim 23, wherein the transparent window is produced in the substrate by respectively punching windows out of the windowless substrate on one side and out of a window material on the other side, in particular through the same tool and the punched out component made from window material is inserted into the punched out pass through of the substrate and fixated therein.

37. The method according to claim 23, wherein a fixation is performed through laminating a transparent foil which extends over the window and the substrate in particular on both sides.

38. The method according to claim 21, wherein the continuous substrate in particular on both sides is imprinted with a basic design or configured through gluing on a foil before punching the pass through for the window out of the substrate.

39. The method according to claim 21, wherein the basic design includes safety elements like UV detectable print images, micro printing, iris print and Guilloches.

40. The method according to claim 23, wherein punch markers are for subsequently punching out the pass through for the window material also applied during an application of the basic design on the substrate.
